(19) United States
(12) Patent Application Publication
(10) Pub. No.: US 2007/0074888 A1
(43) Pub. Date: Apr. 5, 2007

(54) Edifice prewiring arrangement for in-house signal consolidation and distribution system

(75) Inventors: Russell Page, Palmyra, NY (US); William H. Thompson, Pittsford, NY (US); Scott Gales, Masham (CA)

Correspondence Address: Shlesinger & Fitzsimmons, Suite 1323, 183 East Main Street, Rochester, NY, 14604, US

(73) Assignee: Upstate Systems Tech. Incorporated, dba UStec

(21) Appl. No.: 11/244,178

(22) Filed: Oct. 5, 2005

(51) Int. Cl. H01H 13/04

(52) U.S. Cl. 174/58

(57) ABSTRACT

A structured wiring system and apparatus and method for preinstallation of cabling therefor in a building, preferably during construction thereof. A cabling support bracket holds cabling in place at a central signal receiving and distribution location, the bracket including a flange that forces wall finishers to leave a cutout providing access to the cabling. The cabling extends from the central signal receiving location in the building to each prospective access point at which cabling support brackets and wall plates are installed. A filler plate can be mounted on the flange of the support bracket to cover the hole and indicate where the central location is. Additionally, identifiers can be associated with particular installations to provide compensation to the builder who included the preinstallation. When a signal distribution system is to be installed, a cabinet base is placed on the support bracket flange. The cabinet base is a mount on which signal handling modules can be installed and to which a cover can be attached. If necessary, additional cabinets can be attached and knockouts can be removed to allow passage of wires between cabinets.

### CROSS-REFERENCE TO RELATED APPLICATIONS

This application is related to U.S. Pat. Nos. 6,108,331 and 5,114,365 which are incorporated by reference.

### BACKGROUND AND SUMMARY

Distribution of signals, such as those for telephone, antenna, satellite and cable television services, and computer networking, has long been handled by separate cabling within a building for each type of signal. When new signals are added, new cables must be wired, and the separate cabling scheme has been maintained even within newly constructed buildings. Retrofitting an existing structure with new cabling can be difficult and costly.

Wireless solutions have arisen for some applications, but these can be limited in range and quality depending on the protocol used, the materials used in a structure, and the type of signal distributed over the wireless network. Additionally, there can be security and privacy issues surrounding the use of wireless solutions.

To simplify the use of the separate cabling, the different cables can be bundled from a central location in what are known as structured wiring schemes. The signals for different service are received in a cabinet in the central location and cables for each service and for each point of use exit the cabinet. All cables going to a particular point of use are bundled and brought to an access points in a wall of the point of use where they can be connected to respective wall plates and connectors. To further simplify, some structured wiring schemes include wall plates that hold all types of connectors needed for the various cables in the bundle.

Excellent and preferred examples of structured wiring systems include the tecLAN™, ProLAN™, and iLAN™ systems of UStec™, Victor, N.Y. Such systems include a tecCenter™ comprising a rough-in cabinet housing a panel assembly and accessories and is covered by a panel or door. The tecCenter™ receives telephone, television, and data signals from outside the building, as well as audio, visual, data, and other signals from inside the building, and distributes the signals throughout the house over cabling, such as UStec's tecWire™, though conventional wiring can be used. The tecCenter™ includes equipment modules to process, encode, blend, and otherwise control signal amplitude and distribution as necessary. Once implemented, and with appropriate modules installed in the tecCenter™, the user can, for example, view and control satellite or cable television throughout the house without having more than one satellite receiver or cable box, view and control the output of a DVD player in one room of the house from another room in the house, listen to and control audio from any suitable audio device in one part of the house from any other room in the house, and access an in-house computer network from anywhere in the house. Further, an appropriately equipped tecLAN™, ProLAN™, or iLAN™ can be used to control environmental equipment in the building, view security and other cameras connected to the system, and control lighting in the building, among many other features.

The tecLAN™, ProLAN™, and iLAN™ systems are excellent systems and are easy to install in any home or other building during construction. However, this requires that the owner and/or ultimate resident of the home or building instruct the builder to install such a system. For buildings constructed before the resident(s) of the building are known or own the building, such as spec houses and new spec office buildings and the like, such systems are less likely to be installed since installing the cabinet and running cabling from the central location to each access point can be expensive.

To avoid some of the expense, builders can opt to run cabling to each access point, install wall plates with the various connectors that will be needed, but not include a cabinet and/or tecCenter™. However, access to the cabling at the typical tecCenter™ installation point can then be a problem since, after the cabling has been installed, the walls of the building are finished with drywall or the like, painted, etc., so that the cabling is sealed off in the wall cavity.

To overcome this problem of sealed off cabling, embodiments contemplate a prewiring system for an in-house network including a cabling support bracket that holds the cabling in an easily accessible fashion at the cabinet installation location. Embodiments also include a flange that projects through the space that will be occupied by wall finishing material, such as drywall. The flange forces a wall finisher to cut a hole in the finishing material, thereby ensuring access to the supported cabling. Once the wall is finished, a filler plate can be used to cover the hole created by the flange. The fillet plate can be a simple, blank plate, or can have a design or indicia printed thereon. For example, the plate can carry a logo or the like, or can include a unique identifier that the occupant can later use when installing a tec system.

Embodiments also contemplate the use of a multicable that includes all the conductors of bundled cabling from each access point in a single cable. Thus, large, awkward bundles of cables from each access point are eliminated. In place of such bundles, a single cable or pair of cables can be used.

Further, embodiments contemplate a modular cabinet assembly that allows for installation of as much or as little equipment as a user desires for a central server. A base plate attaches to the flange of the cabling support bracket and provides one or more mounting points for equipment to handle the various signals to enter the cabinet. If more equipment is desired than a single cabinet can handle, additional cabinets can be attached in a train and aligned knockouts can be used to pass wiring from cabinet to cabinet. In embodiments, the modular cabinet arrangement can be used at access points in the structure, though the modular cabinet design is primly intended for use in the central location at which signals are received into the building structured wiring system in place of the large single cabinet typically used in such systems. In embodiments in which a filler plate is omitted, a unique identifier can be applied to one or more cabinet modules.

With this prewiring arrangement and modular cabinet design, the cost of prewiring a structure, such as a spec house, can be greatly reduced. The reduction in cost makes it more likely that builders will install such prewiring arrangements in the speculative buildings they erect. Further, the identification system of embodiments can be used to provide builders a fee or other recognition when occupants of the spec buildings later install a tec system since builder information can be associated with the unique identifier.

### BRIEF DESCRIPTION OF THE DRAWINGS

FIG. 1 is a schematic illustration of a cabling support bracket mounted on a building support according to embodiments.

FIG. 2 is a close-up schematic illustration of the cabling support bracket mounted on a building support according to embodiments seen in FIG. 1.

FIG. 3 is a schematic illustration of a cabling support bracket mounted on a building support according to embodiments after wall finishing material has been mounted over the cabling support bracket.

FIG. 4 is a schematic illustration of a cabling support bracket mounted on a building support according to embodiments after wall finishing material has been mounted over the cabling support bracket and with a filler plate mounted thereon according to embodiments.

FIG. 5 is a schematic illustration of a cabinet base mounted on a building support over the cabling support bracket and/or wall finishing material according to embodiments after wall finishing material has been mounted over the cabling support bracket.

FIG. 6 is another schematic illustration of a cabinet base mounted on a building support over the cabling support bracket and/or wall finishing material according to embodiments after wall finishing material has been mounted over the cabling support bracket, this view showing the aligned flanges and opening in the base according to embodiments.

FIG. 7 is a schematic illustration of a cabinet base mounted as in FIG. 6, but with two additional cabinet bases daisy chained therewith using the tabs, recesses, and knockouts according to embodiments.

FIG. 8 is a schematic top view illustration of a cabinet base and cover mounted on a finished wall according to embodiments.

FIG. 9 is a schematic flow diagram of a method according to embodiments.

FIG. 10 is a schematic flow diagram of a method according to embodiments.

FIGS. 11 and 12 are schematic close-ups of the cable support arrangement according to embodiments.

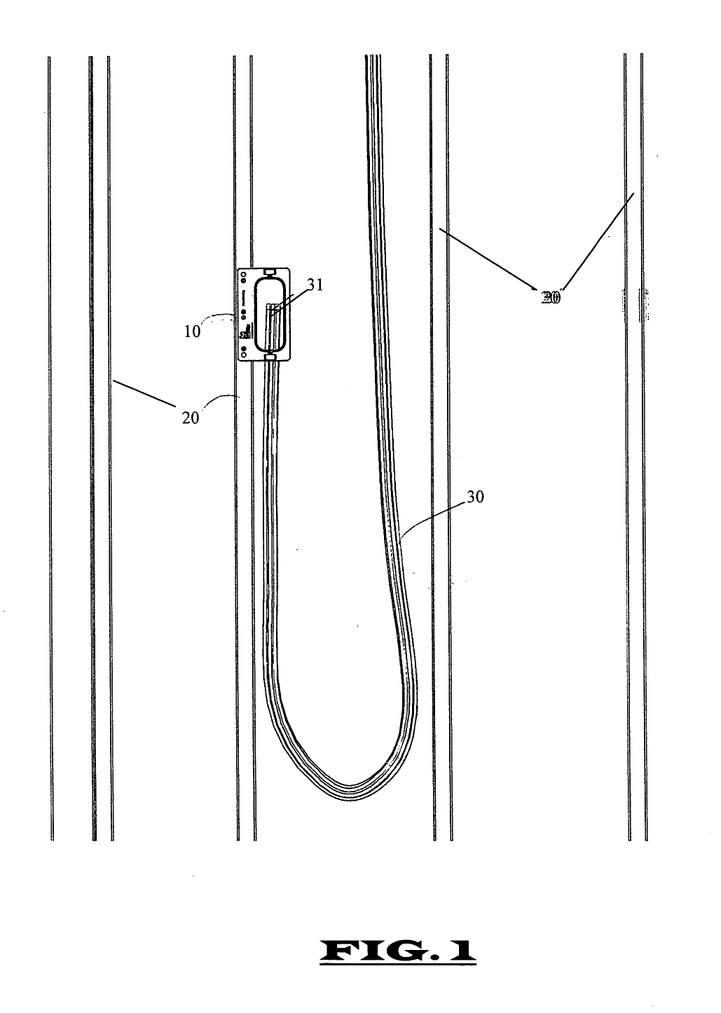

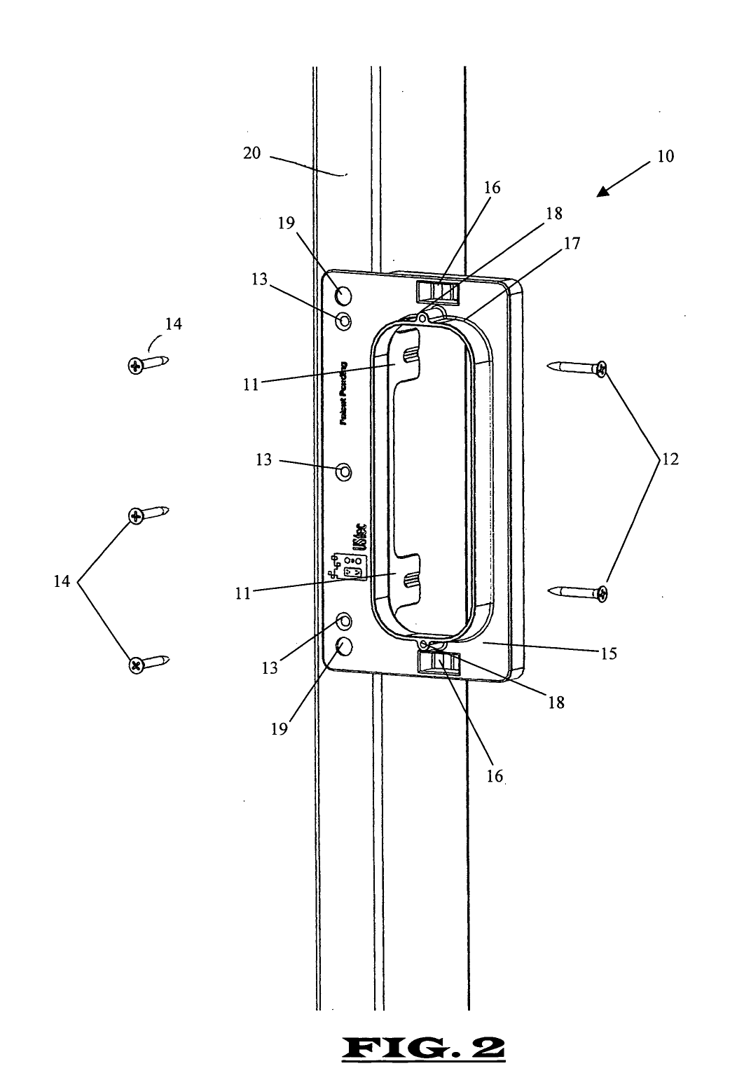

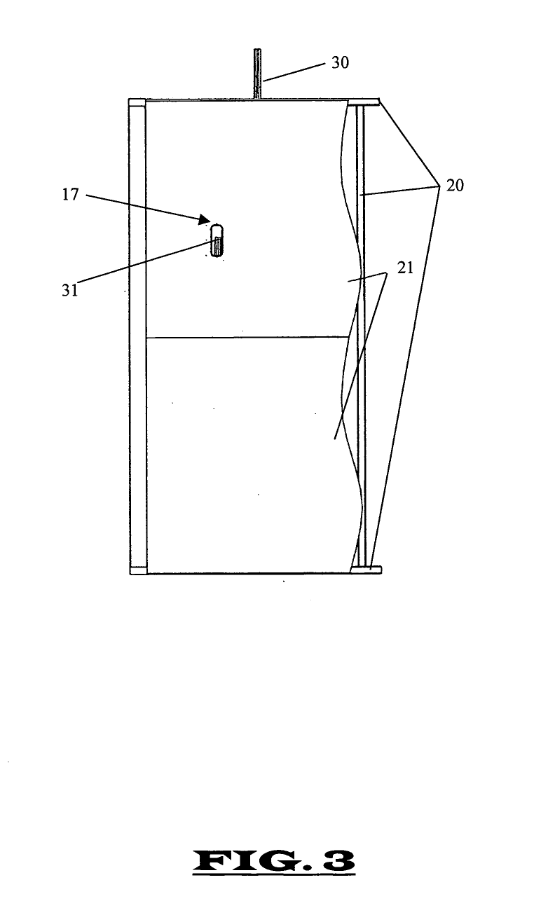

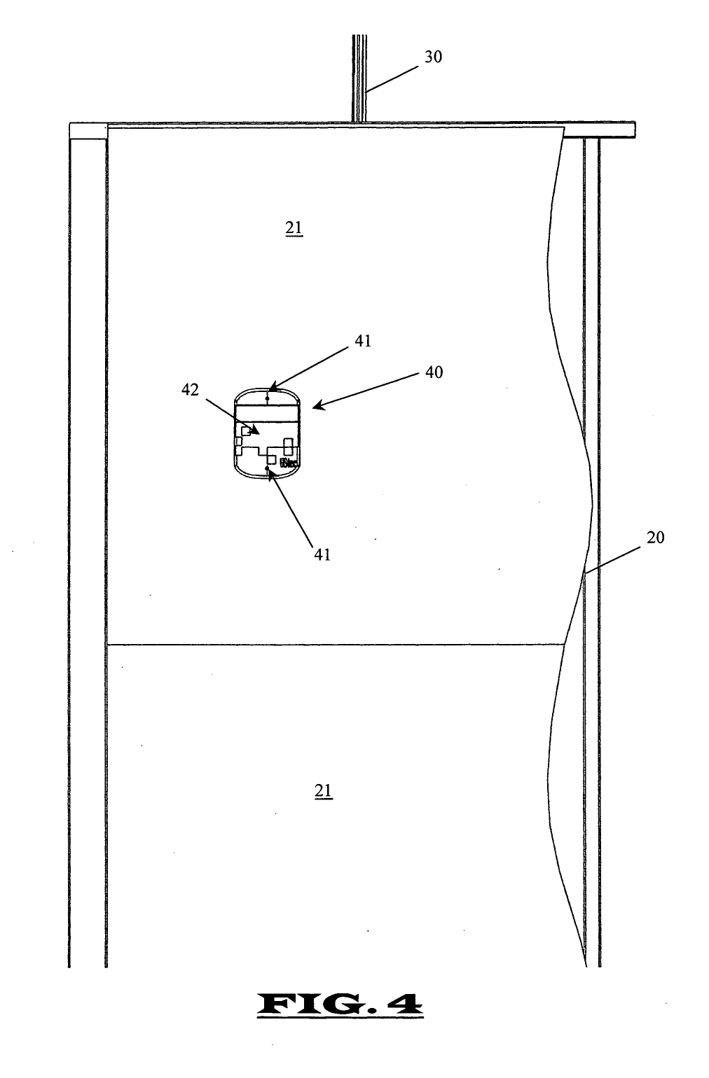

### DESCRIPTION

For the sake of simplicity, embodiments will be described in terms of a residential building, such as “spec house.” However, embodiments can be employed in any suitable building.

A structured wiring system is contemplated in a house and will include a central location at which signals are received into the system, a plurality of access points in the house, and cabling 30 to the access points from the central location. “Central location” here simply means a point at which the signals are gathered together for distribution, not that the location itself is in a physically central location within the edifice. Preferably, embodiments employ a multicable as the cabling 30, the multicable including all the conductors associated with the signals required at each access point and/or received at the central location. Alternatively, embodiments can employ two cables or even one cable over which multiplexed or otherwise encoded and blended signals are carried. As an additional alternative, all signals can be digitized and represented as data packets and the cabling 30 can be category 5 cabling such as is used for Ethernet networks. In another alternative, conventional cabling is used and gathered at the central location. Embodiments preferably employ a multicable with two coaxial cables and two Cat5e cables, such as the tecWire™ sold by UStec of Victor, N.Y.

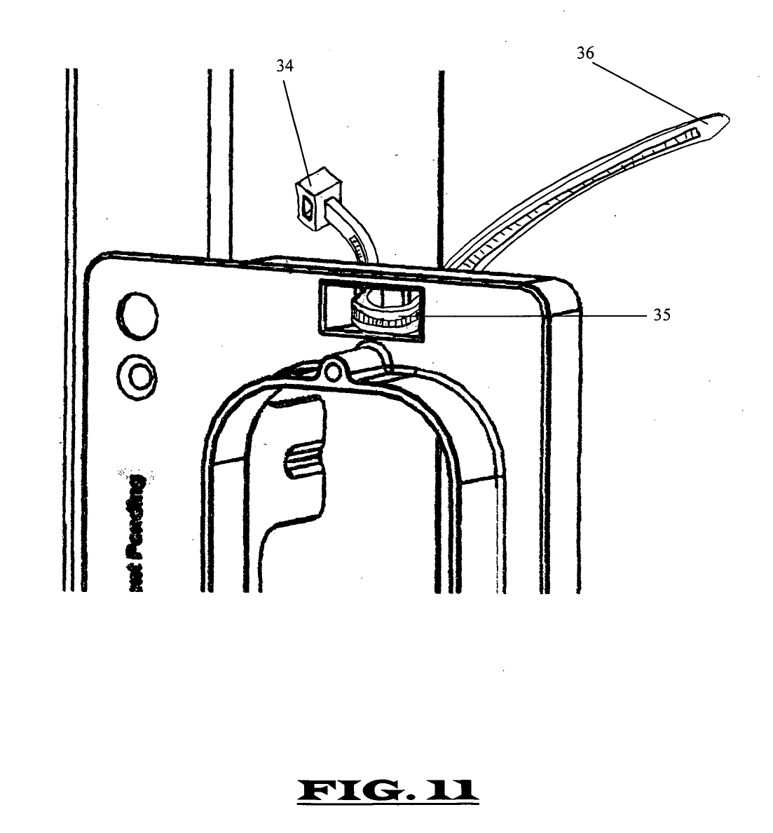

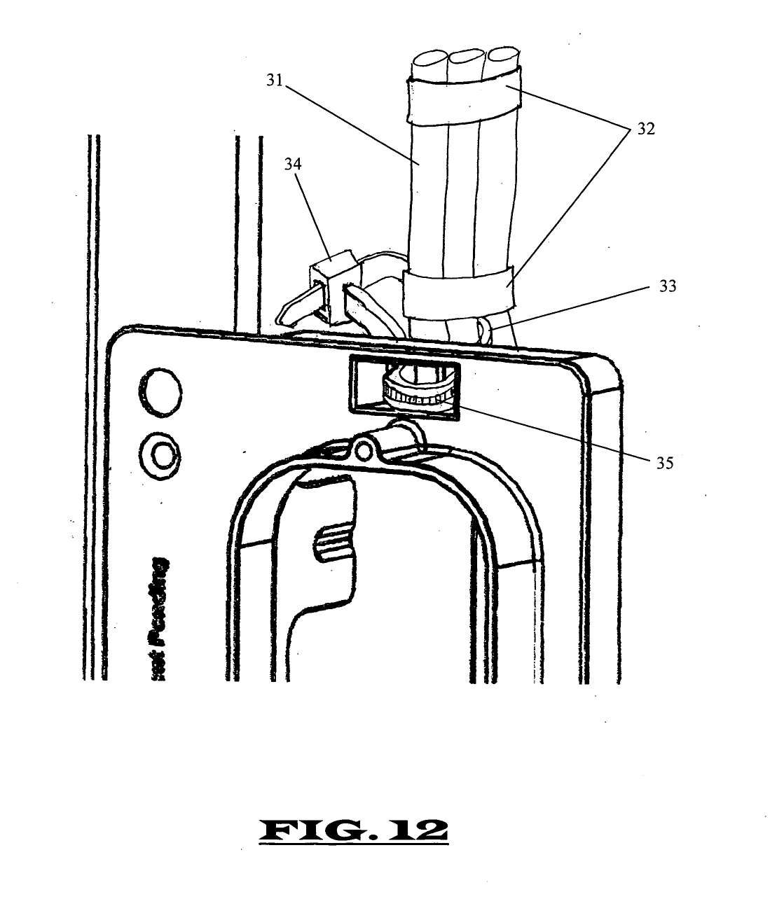

Embodiments include a cabling support bracket 10 at the central location that attaches to a support structure 20, such as a stud in a framed house. The bracket has a mounting flange 11 through which wood screws 12 or the like secure the bracket to the stud. Mounting holes 13 and mounting screws 14 can pass through a plate 15 that extends from the mounting flange parallel to the future finished wall surface. Cabling holders 16 protrude from the bracket near a cutout with an alignment flange 17 protruding toward the center of the room. The flange 17 protrudes far enough that it will extend a couple of millimeters beyond drywall or other finishing material 21 that will be placed on the wall. Before drywall is installed, the cabling 30 from each access point is brought to the central location, and ends 31 of the cabling 30 are secured to the attachment point 16 on the bracket 10 with plastic ties or the like as particularly seen, for example, in FIGS. 11 and 12. Preferably, adhesive tape or the like 32 is wrapped around the cabling 30 several inches before an end 31 of the cabling 30 and a plastic tie 35 is passed through the attachment point 16, through a gap 33 between wrapped wires in the cabling 30 and under the tape 32, and back through the attachment point 16 to be closed. This allows the cabling 30 to be hung by the plastic tie 35, presenting several inches of cabling 30 at the cutout that can simply be grabbed and pulled into the room. Also, ample cabling 30 is preferably left in the wall cavity so that installers have enough to do whatever might need to be done when work is done at the access point.

With the protruding flange 17 around the cutout, a drywaller is forced to cut a hole in the drywall 21 and leave access to the wall cavity through the cutout in the plate 15. Similar accommodations must be made in other finishing materials. After the drywall 21 is installed, a filler plate 40 can be placed over the opening, using, for example, the flange 17 and holes 19 therein as well as holes 41. The filler plate 40 can in embodiments include indicia and/or a unique identifier 42 associated with the builder/installer and/or with the structure into which the tecWire™ system is installed. Alternatively, the unique identifier 42 can be placed on the cabinet if it is installed immediately instead of using a filler plate 40.

The modular cabinet of embodiments can be attached at the central location in place of the filler plate 40 either at the initial installation of the system or later in the life of the edifice. The cabinet includes a base 50 that mounts on the portion of the cutout flange 17 protruding from the drywall 21. This placement of the base 50 on the flange 17 is mostly for alignment, and the cabinet base 50 of embodiments is preferably mounted to the stud via screws extending through holes 55, 19 in the cabinet base 50 and in the bracket mounting flange 15, respectively.

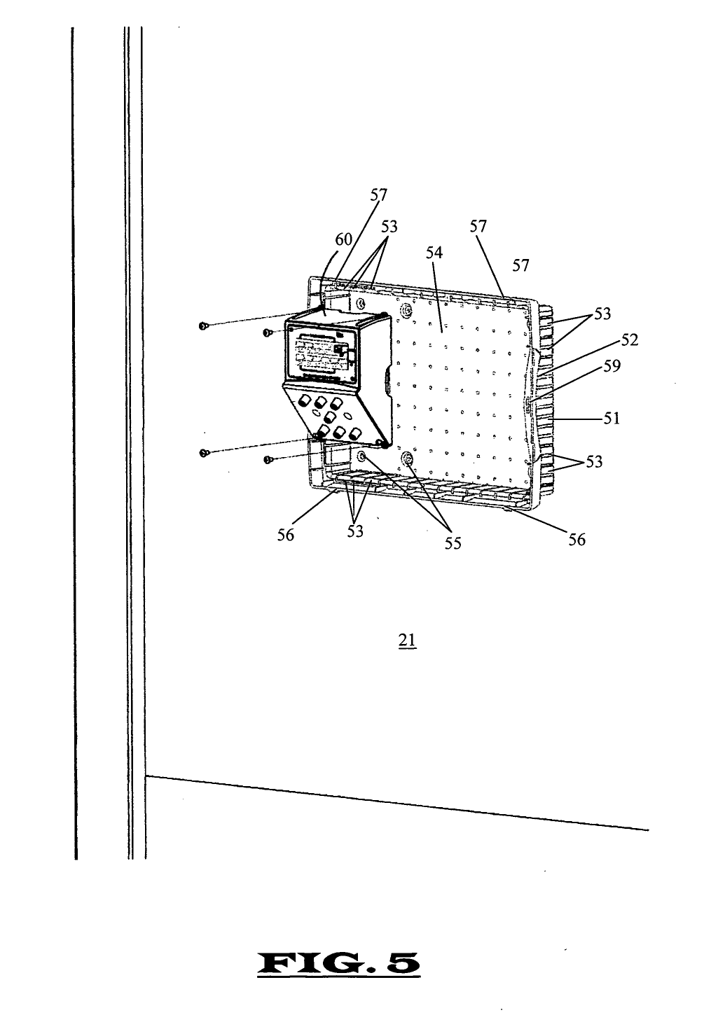

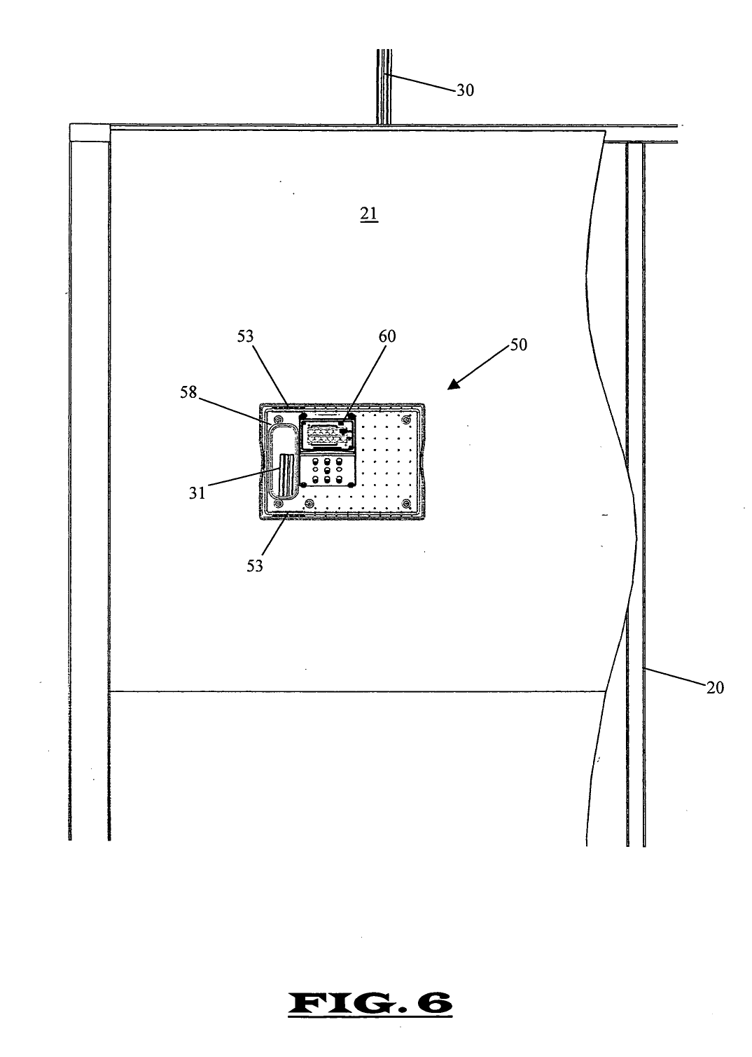

In embodiments, the cabinet base 50 includes a matrix of holes 54 with which equipment modules 60 can be installed in the cabinet, such as the basic telephone and coaxial television signal splitter module shown in FIG. 5. The cabinet base 50 is preferably substantially rectangular with walls 51 on all sides protruding into the room when mounted. At least two of the walls preferably include a plurality of through holes or slots 52 to allow ventilation for cooling of modules 60 installed in the cabinet. The cabinet base 50 further includes a through hole and flange 58 that match the cutout in the bracket plate so that the ends 31 of the cabling 30 can be pulled through to modules 60 installed on the cabinet base 50. Embodiments include a cover 70 placed on the cabinet base 50 with a latching system 59, 71 holding the cover 70 to the base 50. Corresponding lock tabs can be included on both the cover and the base to impede entry into the cabinet.

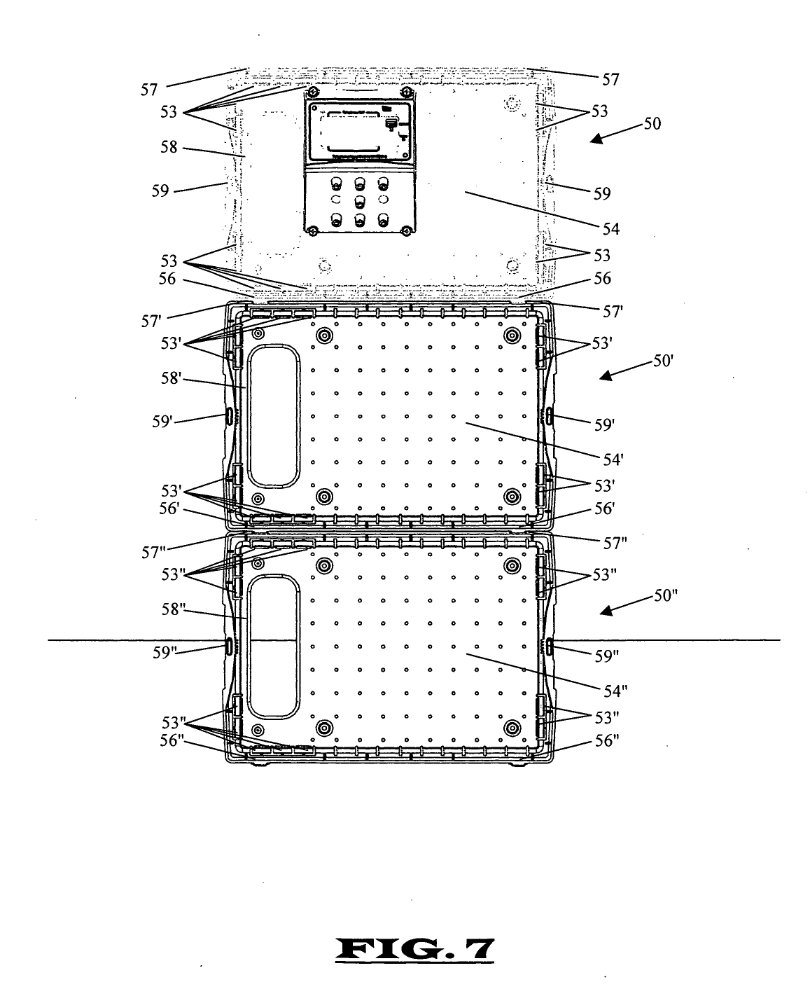

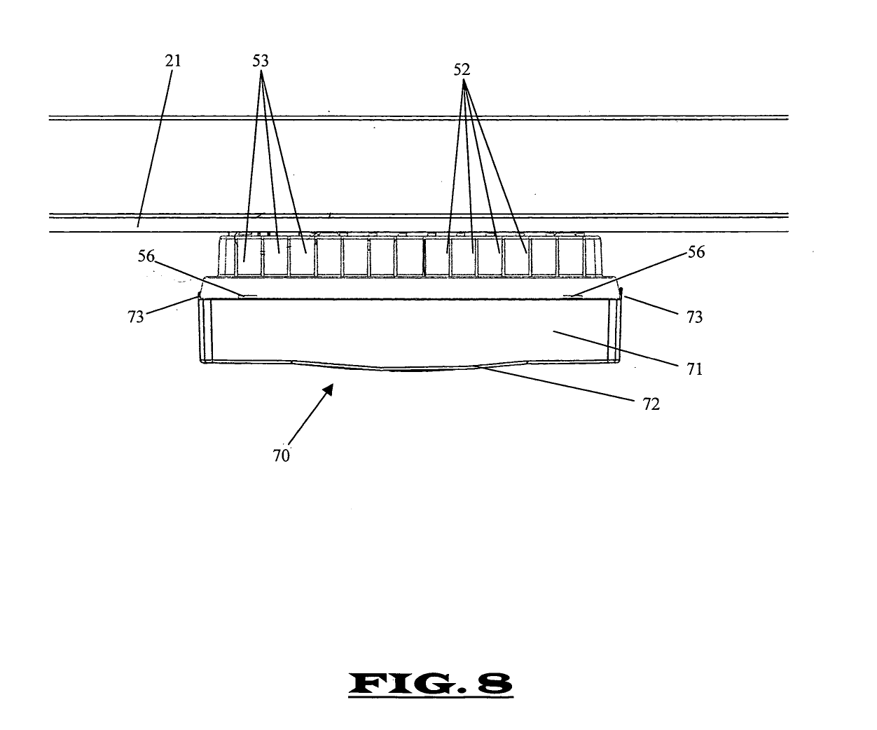

If more modules 60 are desired than one cabinet can accommodate, one or more additional cabinets 50′, 50″ can be added to the system in a modular fashion, such as is seen in FIG. 7. To speed alignment of the bases, at least one wall 51 of each base includes tabs 56 on an external face and mating holes 57 on the external face of at least one opposite wall 51. The tabs 56 of one base are received by mating holes 57 of a corresponding adjacent base 50 when properly mounted. This is seen in FIG. 7, where tabs 56 of a first base 50 are received in the recesses 57′ of a second base 50′, and tabs 56′ of the second base 50′ are received in recesses 57″ of a third base 50″. To allow connection between modules and/or across cabinets, the walls 51 of the cabinet bases include one or more weakened portions or knockouts 53 that can be removed to make cable passthroughs. As seen, for example, in FIG. 7, when the cabinet bases 50, 50′, 50″ are mounted, the knockouts 53, 53′, 53″ are aligned for easy, compact feeding of the cabling 30 or other connecting media.

The filler plate 40 that covers the prewiring bracket hole of embodiments can take one of many forms. It can be a simple blank plastic plate, or can carry indicia 42. For example, the indicia 42 can carry artwork or a company logo, and/or can include a unique identifier for the installation that can be used in one of several ways. In embodiments, the unique identifier can be used to associate the installation with the home owner, the builder of the home, both the owner and the builder, and more. In such an arrangement, the builder could get a fee for each installation when the home owner calls with the unique identifier. Rather than forming or printing unique identifiers 42 on the filler plates 40 directly, embodiments contemplate printing the unique identifiers 42 stickers that can be applied to the filler plates 40 or to the cabinet bases 50 or both, depending on exactly how the system is implemented.

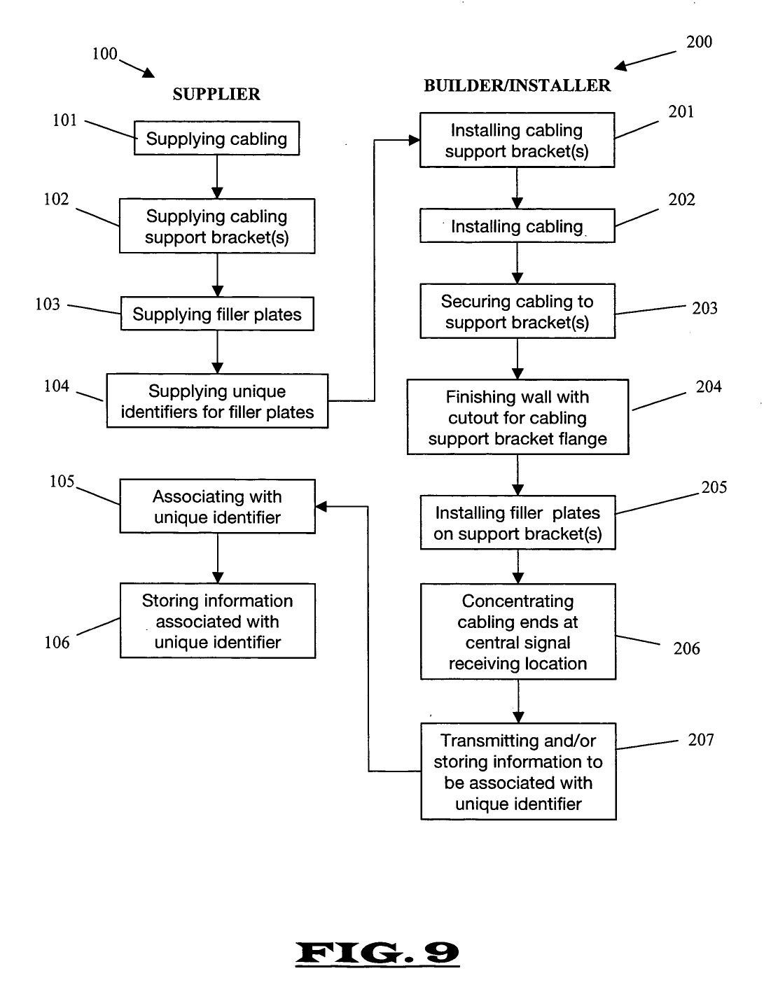

With particular reference to FIG. 9, embodiments thus also contemplate a method of distributing a structured wiring product comprising a supplier 100 contracting with builder/installers 200 to install the product in all new builds. In embodiments, the method can include supplying cabling 101 and supplying cabling support brackets 102, though some installers will use cabling 30 from other sources. Further, the method can include supplying filler plates 103, preferably including supplying unique identifiers 104 that can be associated with particular entities, such as particular builders, particular buildings, particular installs, particular access points, or any mixture of these. Alternatively, as discussed above, the unique identifiers 42 can be placed on the cabinets in addition to or rather than the filler plates 40. In either case, embodiments include associating the identifiers 105 and storing the information associated with the identifiers 106, which would be retrieved by or from an occupant/owner when it is time to install or expand a tec system. The method can include the steps required by the builder/installer 200, as well. For example, embodiments can include installing a cabling support bracket 201, installing cabling 202, such as from a point of reception of signals into the structure to all contemplated access points in the structure, and attaching the cabling to the bracket 203. Further, embodiments can include leaving a loop of cabling in a future wall cavity, leaving a cutout in a wall finishing material around a flange of each cabling support bracket 204, and placing a filler plate on each cabling support bracket flange 205. Embodiments can include concentrating cabling ends at the central signal receiving location 206 and transmitting/storing information to be associated with the unique identifier 207.

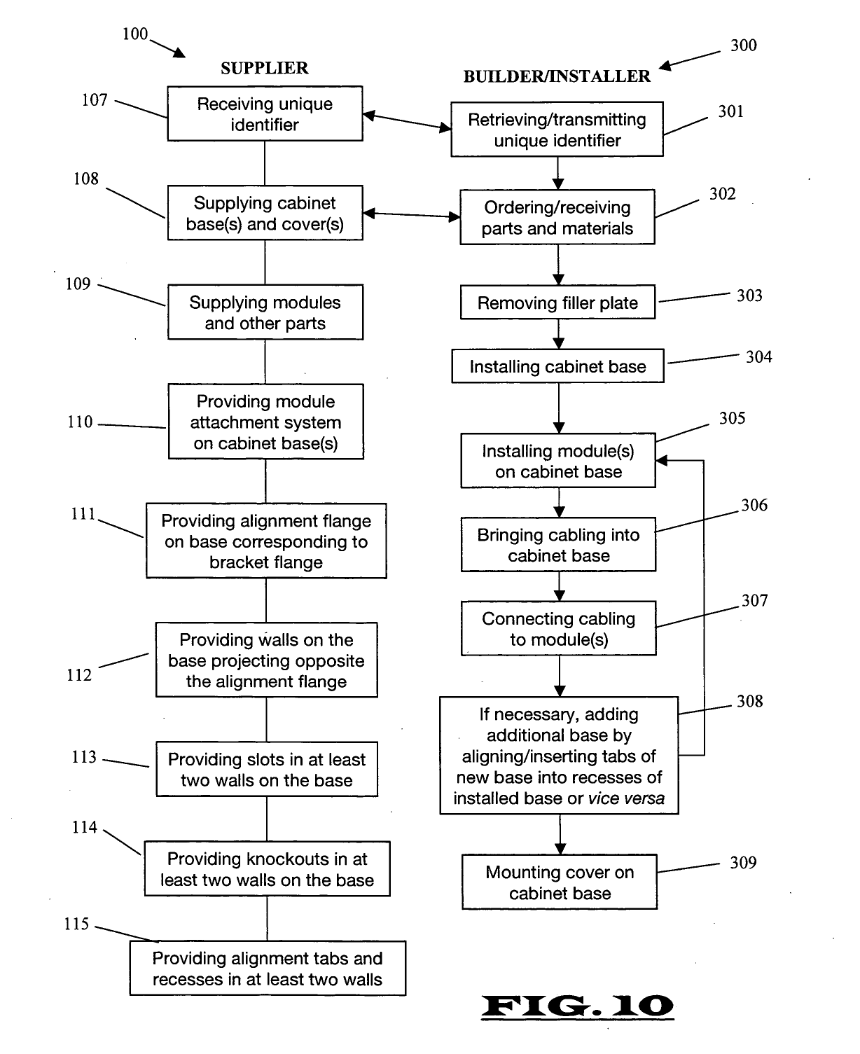

Embodiments further contemplate a method 300 of modular installation and expansion of a signal distribution system using a structured wiring arrangement installed according to the invention as described above as seen, for example, in outline form in FIG. 10. An installer or the occupant/owner of the building can retrieve the unique identifier for the installation from the filler plate 40 or cabinet, depending on what installation path the builder and/or owner chose. Transmitting the identifier 301 and ordering and receiving parts and materials for the new tec system 302 are contemplated in embodiments. On the supplier 100 side, receiving the identifier 107, supplying the cabinet base(s) and cover(s) 108, and supplying module(s) and other parts 109 are part of embodiments. Embodiments also contemplate providing a module attachment system on the cabinet base 110 and providing an alignment flange on the base corresponding to the cabling support bracket flange 111. Additionally, providing walls on the base projecting opposite the alignment flange 112, providing slots in at lest two of the walls to allow air to pass through the assembled cabinet 113, and providing knockouts in at least two of the walls so that two bases aligned adjacent one another will have knockouts aligned 114 are contemplated in embodiments. Further, providing tabs on the external surface of one wall and corresponding recesses on the external surface of an opposite wall 115 facilitates alignment of adjacent cabinets.

When the parts have been received, embodiments comprise removing the filler plate(s) or the cabinet cover(s) 303, installing the cabinet base(s) 303 by mounting the alignment flange on the bracket flange, and installing modules on the base(s). Bringing cabling into the first cabinet base 306 and connecting the cabling to the module(s) 307 are contemplated, as well as adding additional base(s) 308 and aligning the additional base(s) by inserting tabs of one into recesses of another or vice versa. When the base(s) and module(s) are installed, the method includes mounting cover(s) on the base(s) 309.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An edifice prewiring arrangement particularly suited to residential use comprising:
a bracket adapted to attach to a support in an edifice, the bracket comprising:
a mounting flange through which at least one attachment device secures the bracket to the support;
a mounting plate that extends parallel to a future wall surface and including:
a cutout;
an alignment flange protruding from the cutout toward a center of a future room;
a protrusion distance of the alignment flange being exceeding a thickness of drywall that will be placed on the wall;
a cabling holder on a back of the plate;
cabling for an in-house signal consolidation and distribution system extending to at least one access point from the location of the bracket;
ends of the cabling secured to the cabling holder on the back of the plate;
whereby ample cabling is left in a future wall cavity to allow future work with the cabling while access to the ends of the cabling is ensured by the protrusions and the cutout of the plate.

2. The prewiring system of claim 1 further comprising a filler plate that can be placed over the cutout after drywall is installed, the alignment flange providing alignment and support for the filler plate.

3. The prewiring system of claim 1 wherein the cabling holder comprises a tongue with holes therein sized to accommodate a tie that supports the cabling.

4. The prewiring system of claim 1 wherein the bracket is formed from a single piece of material so that at least the mounting flange and mount plate are portions of a single piece of material.

5. An edifice in-house signal distribution system cabinet comprising:
a base plate;
a cutout in the base plate of substantially identical dimension to a stud bracket mounting plate;
a mounting flange projecting from a periphery of the base plate cutout and adapted to fit inside the stud bracket alignment flange;
a plurality of attachment points in the base plate configured for easy attachment of devices to be housed in the cabinet;
walls projecting from the base plate and adapted to project away from the stud bracket;
a plurality of cooling slits in at least two of the walls to allow air to flow through the cabinet to cool equipment housed therein; and
at least one knock-out in at least one wall configured to align with at least one corresponding knock-out in at least one adjacent cabinet; and
a selectively removable cover comprising a top plate and walls projecting from the top plate to fit over the base plate walls and be supported and retained thereby.

6. The cabinet of claim 5 further comprising at least one tab in a first base plate wall and at least one corresponding recess in a second base plate wall opposite the first base plate wall so that the at least one tab of a first cabinet can be inserted into the at least one corresponding recess of a second cabinet disposed adjacent the first cabinet, thereby ensuring proper alignment of the first and second cabinets.

7. The cabinet of claim 5 further comprising corresponding locking tabs on a base plate wall and a cover wall arranged to allow use of a lock to impede access to an interior of the cabinet when assembled.

8. An in-house signal consolidation and distribution system comprising:
a central signal receiving and distribution location at which a signal distribution server adapted to receive a plurality of signals and distribute the signals to at least one location can be installed;
cabling extending from the central location to the at least one location;
a wall plate at each of the at least one location receiving and supporting the cabling;
a bracket at the central location receiving and supporting the cabling;
at least one cabinet at the central location attached to the bracket and having a base, walls on the base, and a cover, the base being substantially parallel to the bracket, the walls projecting away from the base, the cabinet housing at least one signal handler module connected to the cabling and configured to provide a respective signal carried by the cabling to a device in communication with the signal handler that can use the signal; and
at least one wall of the cabinet including a removable portion adapted to align with a removable portion of an adjacent cabinet when such adjacent cabinet is present such that at least one of the cabling and connecting wires can be passed between adjacent cabinets.

9. An in-house signal distribution and prewiring system comprising:
a central location at which signals can be received and distributed;
a support bracket at the central location;
at least one access point;
cabling between the at least one access point and the support bracket;
the support bracket comprising:
a mounting flange arranged to be placed against a wall support;
attachment holes in the mounting flange through which the mounting plate and stud bracket are attached to the wall support;
a mounting plate substantially perpendicular to the mounting flange;
a cutout in the mounting plate;
an alignment flange protruding from a periphery of the cutout and away from the mounting flange; and
a cabling holder adapted to retain the cabling within reach of the cutout; and
a first cabinet mountable on the support bracket, the cabinet comprising:
a base plate;
a cutout in the base plate of substantially identical dimension to the support bracket mounting plate;
a mounting flange projecting from a periphery of the base plate cutout and adapted to fit inside the support bracket alignment flange;
a plurality of attachment points in the base plate configured for easy attachment of devices to be housed in the cabinet;
walls projecting from the base plate and adapted to project away from the support bracket;
a plurality of cooling slits in at least two of the walls to allow air to flow through the cabinet to cool equipment housed therein; and
at least one knock-out in at least one wall configured to align with at least one corresponding knock-out in at least one adjacent cabinet; and
a selectively removable cover comprising a top plate and walls projecting from the top plate to fit over the base plate walls and be supported and retained thereby.

10. The system of claim 9 further comprising a blind filler plate adapted to be mounted on a respective support bracket alignment flange to cover a respective cutout of the bracket and in drywall mounted after prewiring.

11. The system of claim 10 further comprising indicia on the blind plate adapted to identify at least one of an owner of the system and a contractor who installed the system.

12. The system of claim 9 further comprising indicia on the first cabinet adapted to identify at least one of an owner of the system and a contractor who installed the system.

13. The system of claim 9 wherein the server comprises at least one additional cabinet adjacent the first cabinet.

14. The system of claim 13 wherein the at least one additional cabinet and the first cabinet arranged with abutting cover side walls so that a knock-out of a cabinet is aligned with a knock-out of an adjacent cabinet under the abutting cover side walls.

15. A structured wiring preinstallation method comprising:
supplying cabling;
supplying cabling support brackets;
installing cabling support brackets at future central signal receiving locations of edifices by attaching the brackets to respective wall support structures;
installing cabling by extending cabling from the central signal receiving locations to access points of respective edifices;
securing cabling ends to respective cabling support brackets; and
finishing walls with cutouts providing access to the cabling and cabling support brackets.

16. The method of claim 15 further comprising supplying filler plates and installing filler plates over the cutouts.

17. The method of claim 15 further comprising supplying unique identifiers for each installation.

18. The method of claim 17 wherein supplying unique identifiers comprises printing the identifiers on at least one component of each installation.

19. The method of claim 17 further comprising associating information about each installation with one of the unique identifiers.

20. The method of claim 15 further comprising supplying at least one cabinet base and at least one respective cabinet cover and supplying at least one module.

21. The method of claim 20 wherein supplying at least one cabinet base comprises providing a module attachment system on the base.

22. The method of claim 20 wherein supplying at least one cabinet base comprises providing walls arranged to project into a room in which the cabinet base will be mounted.

23. The method of claim 22 wherein supplying at least one cabinet base further comprises providing slots in at least two walls.

24. The method of claim 22 wherein supplying at least one cabinet base further comprises providing knockouts in at least two walls.

25. The method of claim 22 wherein supplying at least one cabinet base further comprises providing tabs in at least a first wall external surface and recesses in at least a second, opposed wall external surface, and arranging the tabs so that tabs of one base will align with recesses of an adjacent base.

26. The method of claim 15 further comprising providing attachment points on the base for the cover.

27. The method of claim 15 further comprising installing at least one cabinet base, installing at least one module on the at least one cabinet base, bringing the cabling into the cabinet base, and connecting cabling to the at least one module as appropriate.

28. The method of claim 27 wherein installing at least one module comprises installing at least two modules and the method further comprises connecting the at least two modules with wiring as appropriate.

29. The method of claim 27 further comprising aligning adjacent bases, removing corresponding knockouts of adjacent base walls, and running at least one of cabling and wiring between adjacent bases through the knockouts.

30. The method of claim 27 further comprising transmitting a unique identifier to a supplier, the supplier retrieving information associated with the unique identifier, and compensating at least one of a builder and an installer based on the unique identifier and the information associated therewith.
